(19) United States
(12) Patent Application Publication
(10) Pub. No.: US 2013/0205195 A1
(43) Pub. Date: Aug. 8, 2013

(54) Managing Content from Structured and Unstructured Data Sources

(71) Applicants: Mohamed Dekhil, Santa Clara, CA (US); Chetan Kumar Gupta, Austin, TX (US)

(72) Inventors: Mohamed Dekhil, Santa Clara, CA (US); Chetan Kumar Gupta, Austin, TX (US)

(21) Appl. No.: 13/878,481

(22) PCT Filed: Oct. 19, 2010
(86) PCT No.: PCT/US10/53222

§ 371 Date: Apr. 9, 2013

(51) Int. Cl. G06F 17/21

(52) U.S. Cl. CPC G06F 17/218
USPC 715/234

(57) ABSTRACT

The present disclosure provides a computer-implemented method (300) of managing content from structured and unstructured data sources. The method (300) includes adding a first item to an information management project, wherein the first item includes unstructured content selected from an unstructured data source and a data link corresponding to the unstructured content (304). The method (300) also includes adding a second item to the information management project, wherein the second item includes a database query and structured data corresponding to the database query (306). The method (300) also includes generating a presentation document based on the information management project, the presentation document comprising the unstructured content and the structured data (308).

### BACKGROUND

In many organizafions, reports, summaries, and other documents are often prepared for management and executives to make informed decisions on the directions and strategy of their organization. Such reports may be prepared by experts who gather data from different sources including internal enterprise database, external information from industry analysts related to market trends, information from relevant Websites, among others. A report preparer may combine this data into a single report and include summaries, commentaries, conclusions, and the like. This process is generally performed in an ad hock manner with experts collecting the relevant data and merging it into the report.

### BRIEF DESCRIPTION OF THE DRAWINGS

Certain embodiments are described in the following detailed description and in reference to the drawings, in which:

FIG. 1 is a block diagram of a system that may be used to implement an information management system, in accordance with embodiments;

FIG. 2 is a block diagram of an information management application, in accordance with embodiments;

FIG. 3 is method of generating an information management project, in accordance with embodiments; and

FIG. 4 is a block diagram showing a non-transitory, computer-readable medium that stores code configured to provide management of data from structured and unstructured data sources, in accordance with embodiments.

### DETAILED DESCRIPTION OF SPECIFIC EMBODIMENTS

Embodiments described herein provide an information management system for capturing, organizing, and sharing different types of information from multiple sources including Websites, databases, mobile phones, document repositories, and the like. The information management system can gather information from structured, unstructured, and semi-structured data sources. As used herein, the term “structured data” refers to data wherein the semantic meaning of the stored data is explicitly defined. For example, a structured data source may include relational databases, hierarchical databases, and the like. The term “unstructured data” is used to refer to data wherein the semantic meaning of the data is not explicitly defined. For example, unstructured data can refer to plain text documents, scanned documents, ADOBE® Portable Document Files (PDFs), Microsoft® Word documents, and Web content such as online news and blogs, among others. The term “semi-structured data” is used herein to refer to data wherein the semantic meaning of the data is encoded, for example, using metadata tags. Examples of semi-structured documents include eXtensible Markup Language (XML) files, and HyperText Markup Language (HTML) tiles, among others.

The information management system simplifies the process of gathering information related to a particular task or project and forming a report from the collected data. The information management system can automatically produce the results in a presentation document for publishing or printing. Furthermore, the results stored to the report document, referred to herein as a “project,” can include data links to the source of the gathered information, for example, links to Websites, file system locations of relevant documents, database queries, among others. In this way, the report document captures the experience of the report preparer in terms of the steps taken to compose the report, for example, the queries used against the database, the Websites that were used to collect some of the information, and the analyst reports and market research that was used or referenced in the report. Thus, future reports may be automatically generated by updating the information in an existing report based on the stored data links. Providing an automated process to update existing reports saves the report preparer from repeating previous searches and queries and reintroducing the new results into the updated report.

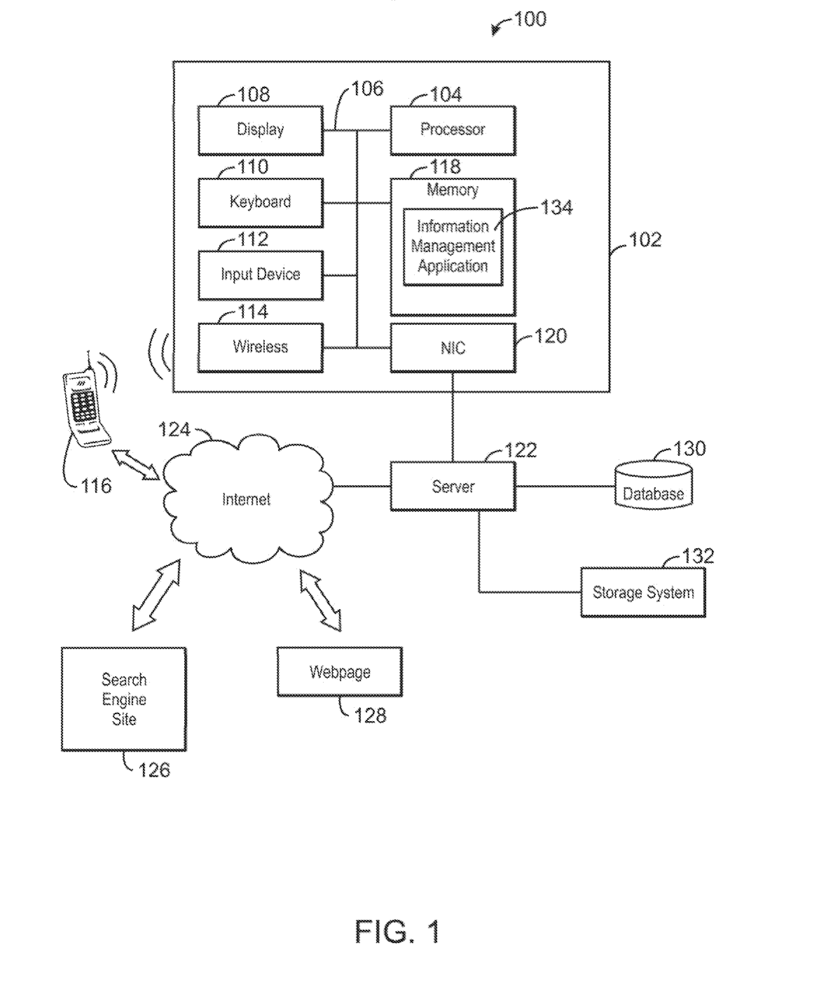

FIG. 1 is a block diagram of a system that may be used to implement an information management system, in accordance with embodiments of the invention. The system is generally referred to by the reference number 100. Those of ordinary skill in the art will appreciate that the functional blocks and devices shown in FIG. 1 may comprise hardware elements including circuitry, software elements including computer code stored on a non-transitory, computer-readable medium, or a combination of both hardware and software elements. Further, the configuration is not limited to that shown in FIG. 1, as any number of functional blocks and devices may be used in embodiments of the invention. Those of ordinary skill in the art would readily be able to define specific functional blocks based on design considerations for a particular system.

As illustrated in FIG. 1, the system 100 may include a computing device 102, which will generally include a processor 104 connected through a bus 106 to a display 108, a keyboard 110, and one or more input devices 112, such as a mouse, touch screen, or keyboard. The processor 104 can also be connected through the bus 106 to a wireless interface 114 such as a Bluetooth or WiFi interface, among others. Through the wireless interface 114 the computing device can be operatively coupled to various external electronic devices such as a mobile phone 116, printer, scanner, and the like.

The processor 104 can also be connected through the bus 106 to a memory 118 comprising a non-transitory, computer-readable medium. The memory 118 may include volatile memory such as Random Access Memory (RAM) used during the execution of various operating programs, including operating programs used in embodiments of the invention. The memory 118 can also include a storage system for the long-term storage of operating programs and data, including the operating programs and data used in embodiments of the invention. For example, the memory 108 can include a hard disk drive, an array of hard disk drives, an optical drive, an array of optical drives, a non-volatile memory, a universal serial bus (USB) drive, a digital versatile disk (DVD), a compact disk (CD), and the like. In embodiments, the computing device 102 is a general-purpose computing device, for example, a desktop computer, laptop computer, and the like.

In embodiments, the device 102 includes a network interface controller (MC) 120, for connecting the device 102 to a server 122. The computing device 102 may be communicatively coupled to the server 122 through a local area network (LAN), a wide-area network (WAN), or another network configuration. The server 122 may have a non-transitory, computer-readable media, such as a storage device, for storing enterprise data, buffering communications, and storing operating programs of the server 122. Through the server 122, the computing device 102 can connect to the Internet 124 and access one or more search engine sites 126, Web pages 128, and the like. In embodiments, the computing device 102 can also communicate with the mobile device 116 through the Internet 124.

The computing device 102 and server 122 may also be able to access a database 130, which may be connected to the server 122 through the local network, for example. The database 130 can be a relational database, hierarchical database, data warehouse, data mart, and the like. In embodiments, the database 130 can include operational data generated in the course of operating a business or other enterprise. For example, the database 130 can include information used to manage resources of an enterprise, such as financial resources, human resources, materials, equipment, and other tangible and intangible assets. In embodiment, the database 130 can include information used to track and manage the movement and storage of raw materials, work-in-process inventory, and finished goods from the supplier to the customer. The database 130 can also include information used to track and manage relationships with customers, clients, and sales prospects of the enterprise. A person of ordinary skill in the art will recognize additional types of operational data that may be stored to the database 130 in a particular implementation. The computing device 100 can be used to perform business intelligence operations against the data stored to the database 130, such as generate reports, perform queries, and the like.

In embodiments, the computing device can also be coupled to a network storage system 132. The network storage system 132 can Include one or more disk drives, a Redundant Array of Inexpensive Disks (RAID), and the like. The computing device 102 can access the storage system 132 for storing and retrieving documents generated in the course of operating the enterprise, including employee work product, technical papers, correspondence, contracts, invoices, legal documents, among others. Documents stored to the storage system 132 may include, for example, power point presentations, emails, Portable Document Files (PDFs), Microsoft Word documents, Spreadsheets, and scanned documents, among others.

The computing device 102 can also include an information management application 134, in accordance with embodiments of the invention. The information management application 134 can be used to access and collect a variety of content from the various data sources accessible to the computing device 102, such as the mobile phone 116, Web pages 128, the database 130, and the storage system 132. For example, the content captured by a user can include a portion or all of a Web page, an audio clip, a video clip, text, graphics, data from a database, and the like. The gathered content can be combined into one or more projects. The project can also include data links that point to specific text, media, or other content captured by the user and incorporated into the project. The project can also include queries configured to gather information from the database 132. The gathered information can be used to generate a report document, and the data links and queries embedded in the report document may be used to quickly update the data or generate new report documents that use some or all of the same information. In embodiments, some or all of the data links may be hidden, in other words, not viewable by the user, In embodiments, some or all of the data links may be displayed in the report document, thus enabling the user to quickly identify the source of the corresponding information. The user's reports can be stored on the storage system 132 and/or the computing device's local memory 134.

In embodiments, the information management application 134 includes a user interface that enables users to build the project. For example, the user interface can enable the user to access Web pages and select portions of a Web page for incorporation into the project, for example, selected portions of text, images, video, audio, structured data and the like. The user interface can also include a file browser that enables the user to search for and access documents located in the storage system 132 or a local storage device, such as the memory 118. The user may then select portions of a document to incorporate into the report. The user interface may also include a query interface 208 that enables the user to generate a query against the database 130.

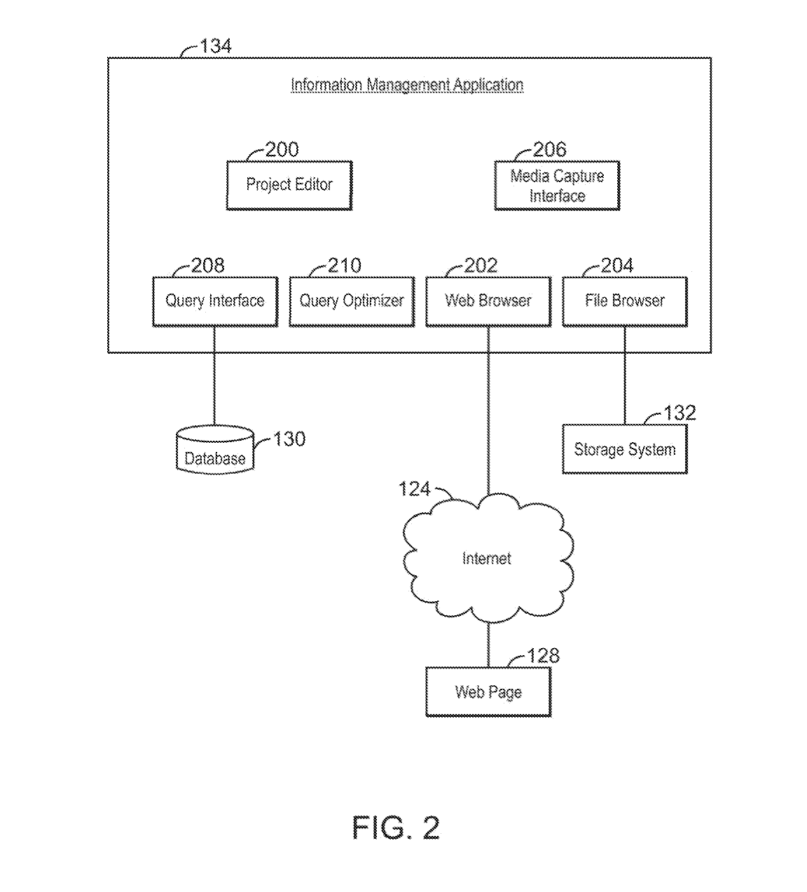

Those of ordinary skill in the art will appreciate that the configuration of the enterprise network 100 is but one example of a network may be implemented in embodiments of the invention. For example, it will be appreciated that the information management application 134 can be hosted by the server 122 and accessed by several computing devices 102 or the mobile device 116 to generate a project. A user of the computing device 102 and/or mobile device 116 can create, manage, and use reports by interacting with the information management application 134 running on the server 122. In embodiments, the information management application 134 may be hosted by a Website and enable client devices to store report documents, for example, to a cloud computing system. Embodiments may be better understood with reference to FIG. 2.

FIG. 2 is a block diagram of an information management application, in accordance with embodiments. The Information management application 134 can be implemented in any suitable computing device, for example, a general purpose computer such as a laptop or desktop computer, a mobile phone, an application server, and the like. The Information management application 134 can also be hosted by a Website. The information management application 134 can include a project editor 200, which can include a graphical user interface. The project editor 200 enables the user to start a new project, open an existing project, edit projects, and the like. The project editor 200 can include editing tools, such as drag-and-drop and copy/paste, to organize the information loaded into the project. The project editor 200 can also include a text editor for manually entering text into the project. In this way, the project editor 200 can be used to organize and frame the data incorporated into the document into an aesthetically pleasing presentation document.

The information management application 134 can also include one or more interfaces that enable the user to incorporate structured and/or unstructured data into the project. For example, unstructured or semi-structured data may be incorporated into the project by a Web browser 202, a the browser 204, and/or a media capture interface 206. Structured data can be incorporated into the project through a query interface 208. The user may access a particular interface by selecting an option provided by the project editor 200 for adding a project item to the project. Each project item can correspond to one of several interfaces, wherein different interfaces are used to select different types of information. For example, the user may add an SQL-type project item, a Web-type project item, and a file-type project item. The interface that will be used to access the data can depend on, the type of item selected by the user.

The Web browser 202 and the file browser 204 enables the user to search for and load unstructured or semi-structured data into the project. Upon selecting the Web-type project item, the Web browser 202 can be initiated, enabling the user to search for content available on one or more Websites or Web pages 128. The Web browser can enable the user to incorporate an entire Web page 128 or a portion of a Web page 128, such as selected text, images, and the like.

The file browser 204 enables the user to search for and incorporate data into the project from the storage system 132. Upon selecting the file-type project item, the file browser 204 can be initiated, enabling the user to search for content available in documents stored to the storage system 132. The file browser 204 can also provide tools that enable the user to view the contents of a document and select portions of the document for incorporation into the project. The user can incorporate an entire document or a portion of a document, such as selected text, images, and the like.

In embodiments, unstructured data such as images, video, or audio can be loaded into the project using a media capture interface 206. For example, in embodiments wherein the information management application 134 is implemented in a mobile phone, the media capture interface 206 can interface with a camera of the mobile phone, for example, to generate a still photograph of a particular item that the user wishes to save to the project. The user may also use the mobile phone to record a voice note to be saved to the project. Other types of media data can be captured the mobile device and stored to the project, such as video files, text messages, contact information, and other types of content. The data link associated with the captured media can identify the source of the media. For example, the data link may indicate that the image, voice message or video message was generated by the user's mobile phone.

The query interface 208 enables the user to generate queries against a database 130. Upon selecting the SQL-type project item, the query interface 208 can be initiated, enabling the user to construct a query to be executed against the database 130. The results of the query can be incorporated into the project, for example, as text, a table of information, a chart, a graph, and the like. The query interface 208 can employ any suitable query language, for example, Structured Query Language (SQL), or other alternatives to SQL such as Memcached and Apache™ Cassandra, among others.

In embodiments, the information management application 134 includes a query optimizer 210. During the execution of a query against a relational database, there may be several alternative procedures, known as query plans, which can be used to access the desired data. The alternate query plans will generally provide varying performance. The query optimizer 210 can evaluate several query plans corresponding to a particular query to identify a more efficient query plan for the query. Further, if a project includes more than one database query, the different query plans associated with the group of queries may include similar steps. possibly resulting in duplicative operations. For example, a query related to overall quarterly sales and a separate query related to quarterly sales for a particular department may both access the same database table. Thus, when a project includes more than one query, the query optimizer 210 can evaluate the group of queries to identify a more efficient query plan that incorporates aspects of several queries rather than merely executing each query individually.

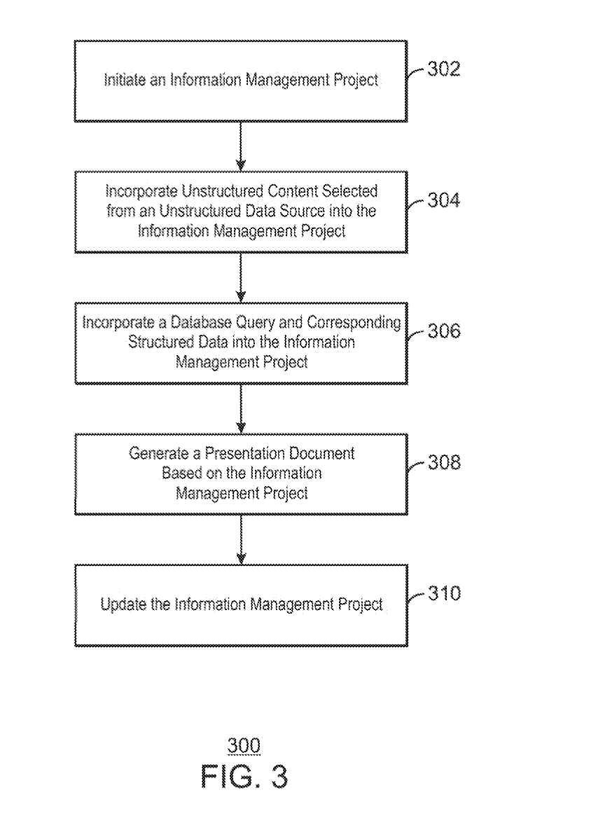

Each project item can include the data selected by the user as well as a data link that indentifies the source of the data. For example, the data l k corresponding to a Web page may include a Uniform Resource Identifier, as well additional identifiers, referred to herein as “bookmarks,” that identify the particular portion of the Web page selected by the user for incorporation into the project. The data link corresponding to a document stored to the storage system 132 may include a file path, file name, as well bookmarks that identify the particular portion of the document selected by the user for incorporation into the project. As discussed further below in reference to FIG. 3, the data links enable the data within the project to be quickly and easily updated automatically or manually.

In embodiments, the project is stored to a shared storage location to enable two or more project authors to work collaboratively to develop the project's content. For example, a project may be shared through an internal Website, the storage system 132, or a cloud computing system, for example. Further, projects can be shared with one or more people with varying levels of access. For example, some users may be allowed to edit a project by adding new content or deleting content. Some users may be given read-only access to a project. Allowing a project to be shared can enable two or more project authors to work collaboratively or provide feedback and comments about the project and its contents.

FIG. 3 is method of generating an information management project, in accordance with embodiments of the invention. The method is referred to by the reference number 300 and may be implemented by the information management application 134 (FIG. 2). At block 302, a new information management project may be initiated. For example, the user may start a new project or open an existing project for viewing, editing, printing, and the like. If the information management application 134 is hosted by a Website or other service provider, the user may be requested to register with the service provider by using a Web browser to access a URL associated with the on-line service. The registration process may include the user providing various demographic information such as name, mailing address, email address, billing information, and the like.

At block 304, unstructured content can be selected from an unstructured data source and incorporated into the information management project. A data link corresponding to the unstructured content can also be acquired and incorporated into the project. In embodiments, the unstructured content may be acquired by the user through the file browser 204. For example, within the project editor 200 the user may select a menu option for generating a file-type project item and navigate to a desired document in the local computing device 102 or the storage system 132, for example. When the desired document is identified, the user may select all or a portion of the document for incorporation into the project. For example, the user may open the document, and select a highlight tool provided by the file browser 204 to place a highlight box at the desired location and drag a corner of the box to select a desired portion of the document. Once the desired portion is selected, the user may select an icon from a tool bar to save the selected media data to the project. The unstructured content incorporated into the project can include can include a photograph or other image, an audio recording, a video recording, multimedia files, text, and the like,

When the user selects content from a document to be incorporated into the project, the information management application 134 generates a data link corresponding to the selected content. For example, the data link may include a file name and file location corresponding to the selected file. If a portion of the document is selected by the user, the information management application 134 can generate the bookmarks that identify the portions of the document selected for incorporation. For example, the user may use the file browser to navigate to a document related to computer sales of the enterprise. The user may then highlight a chart showing projected computer sales growth as well as portions of text related to the chart. The user can then select the highlighted portions for incorporation into the project. The information management application 134 generates the data link that includes the file name, location, and bookmarks identifying the highlighted content. The content corresponding to the data link can be imported in to the project by the information management application 134. The information management application 134 can also record the version of the document so that if a new version of the document is uploaded to the document repository or file system, the report can be updated automatically with the latest version if the user so desired.

In embodiments, the unstructured data may be acquired by the user through the Web browser. For example, within the project editor 200 the user may select a menu option for generating a Web-type project item and navigate to a desired Web page 128 on the Internet 124. When the desired Web page is identified, the user may specify importation of all or a portion of the Web page into the project. In embodiments, the user may highlight selected portions of Web page using a highlight tool as discussed above, and import only the highlighted portions into the project,

When the user selects content from a Web page to be incorporated into the project, the information management application 134 generates a data link to the selected Web page. For example, the data link may include a Uniform Resource Locator (URL) corresponding to the selected Web page. If a portion of the Web page is incorporated into the project, the data link may include bookmarks identifying the portions of the Web page selected for incorporation, for example, portions of text or selected media content. For example, the user may navigate to a Web page that includes reports by one or more industry analysts related to future sales growth in the computer industry. The user may then highlight portions of Web page 128 and incorporate the highlighted portions into the project. The information management application 134 then generates the data link that includes the Web page URL and bookmarks identifying the highlighted content. The content corresponding to the data link can be imported in to the project by the information management application 134.

In embodiments, media data may be loaded into the project using the media capture interface 206, as described in relation to FIG. 2. For example, the user may select a menu option for loading captured media into a project. The project editor may then launch a corresponding interface for capturing the desired data. For example, the user may be directed to a camera application or voice recording application on the user's mobile phone 116 (FIG. 1). The user may then capture the media using the mobile phone, for example, by taking a picture or recording a message and selecting the captured media for incorporation into the project. The information management application 134 can then generate the data link that identifies the source of the captured media. For example, the data link can include an identification of the device used to capture the media, an identity of the device owner, a data and time that the media was captured, and the like.

At block 306, a database query corresponding to a structured data source may be constructed and the data corresponding to the query may be loaded into the project. The project editor 200 may provide a menu option that enables the user to construct the database query. For example, the project editor 200 may enable the user to create an SQL-type project item, such as a table, chart, or graph, to be populated by the data returned by the database query. The user may then be prompted to construct the database query that will be used to acquire the data for generating the SQL-type project item. The user may specify the database 130, a particular table within the database 130, and a set of criteria that defines the database query. Once the database query has been constructed, the database query may be executed against the specified database 130 and the corresponding data can be loaded into the project. The results of the database query may be presented within the project as a table of information, one or more graphs or charts, textual content, as well as other representations which may be selected by the user. The constructed query can be further parameterized to allow other users to customize the results as desired. Examples of query parameters can include start and end dates for the requested data and values within a certain range, among others.

At block 308, a presentation document can be generated based on the information management project. The presentation document can include all of the data selected for incorporation into the project, including the structured and unstructured content. The location of media and other content incorporated into the presentation document may be set automatically, for example, based on the order in which the project items were created. Additionally, project items may be positioned by the user. Other manually generated information may be added to a project, such as annotations and other textual content such as titles, section headings, paragraphs of text, and the like. For example, annotations such as captions or citations may be added to images or other content loaded from a Web page. The user can also add labels to graphs, charts, and tables associated with database queries. In embodiments, some content may be inserted seamlessly into user-generated text. For example, the results of a query configured to provide a single numerical result may be inserted into a sentence with the same font characteristics, such that result appears to be manually entered text.

The data links associated with project content may be displayed in the presentation document. In embodiments, the user may have the option of hiding some or all of the data links so that they are not visible to the reader of the presentation document. Hidden data links may be viewed, for example, by selecting the corresponding content and selecting a menu option for accessing the corresponding data link.

The presentation document can be printed or published, for example, to a Website. Some of the content may be selected or deselected for inclusion in the printed or published project. For example, items in a project may be associated with checkboxes that identify the item for inclusion in the printed or published document.

At block 310, content within the project can be automatically updated using the data links corresponding to each project item. For example, the project may be a quarterly report related to the enterprises finances, which is updated quarterly to reflect the new financial information available for that quarter. When a project is updated, each query within the document may be re-executed against the database 130. Unstructured data may be re-loaded from Websites and other documents that are stored, for example, to the storage system 132 or stored locally, in embodiments, the user may specify which project items are to be updated. For example, the user may specify that only content associated with structured data are to be updated. In embodiments, the user can select individual items for updating.

The data links can also serve as a guide for creating new projects. For example, the user can view the data links associated with a project, thereby informing the user regarding the sources of information used to create the project. New projects may then be similarly generated using the same or similar data. For example, a particular data link may indicate that a paragraph of text incorporated into the project originated from a particular Web page. The user may use this information to search for updated information that may be included in another Web page associated with the same Website. In this way, the user can see the steps taken to produce the original project and take advantage of the effort used to produce the original project, rather than starting from a blank slate and re-discovering the entire process used to generate the original project. This enables reports and other documents to be generated more quickly and efficiently.

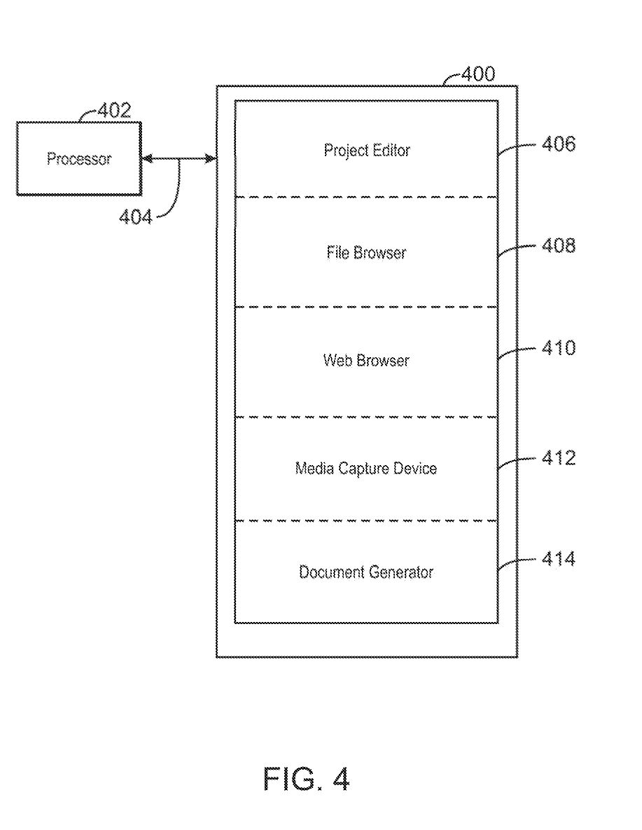

FIG. 4 is a block diagram showing a non-transitory, computer-readable medium that stores code configured to provide management of data from structured and unstructured data sources, in accordance with embodiments of the invention. The non-transitory, computer-readable medium is referred to by the reference number 400. The non-transitory, computer-readable medium 400 can comprise RAM, a hard disk drive, an array of hard disk drives, an optical drive, an array of optical drives, a non-volatile memory, a universal serial bus (USB) drive, a digital versatile disk (DVD), a compact disk (CD), and the like.

As shown in FIG. 4, the various components discussed herein can be stored on the non-transitory, computer-readable medium 400. A first region 406 on the non-transitory, computer-readable medium 400 can include a project editor configured to add various project items to the project, wherein each project item is linked to a structured or unstructured data source. A first item can include unstructured content selected from an unstructured data source and a data link corresponding to the unstructured content. A second item can include a database query and structured data corresponding to the database query. A region 408 can include a file browser configured to access a stored document and enable a user to identify a selected portion of the document for incorporation into the project. A region 410 can include a Web browser configured to access a Web page and enable the user to identify a selected portion of the Web page. A region 412 can include a media capture interface configured to generate media content for incorporation into the project. A region 414 can include a document generator configured to generate a presentation document based on the information management project, the presentation document comprising the unstructured content and the structured data. Although shown as contiguous blocks, the software components can be stored in any order or configuration. For example, if the non-transitory, computer-readable medium 400 is a hard drive, the software components can be stored in non-contiguous, or even overlapping, sectors.

What is claimed is:

1. A method (300) of managing content from structured and unstructured data sources, comprising:
adding a first item to an information management project, the first item comprising unstructured content selected from an unstructured data source (128, 132) and a data link corresponding to the unstructured content (304);
adding a second item to the information management project, the second item comprising a database query and structured data corresponding to the database query (308); and
generating a presentation document based on the information management project, the presentation document comprising the unstructured content and the structured data (308).

2. The method of claim 1, comprising automatically updating the information management project by reloading the unstructured content identified by the data link and re-executing the database query (310).

3. The method of claim 1, wherein adding the first item (304) comprises accessing a stored document and selecting a portion of the document for incorporation into the information management project.

4. The method of claim 1, wherein adding the first item (304) comprises accessing a Web page (128) and selecting a portion of the Web page for incorporation into the information management project.

5. The method of claim 1, wherein the, data link corresponding to the unstructured content and the database query are displayed in the presentation document.

6. A computer system (100), comprising:
a processor (104) that is configured to execute computer-readable instructions; and
a memory device (118) that stores instruction modules that are executable by the processor (104), the instruction modules comprising
a project editor (200) configured to
add a first item to the project, the first item comprising unstructured content selected from an unstructured data source (128, 132) and a data link corresponding to the unstructured content; and
add a second item to the project, the second item comprising a database query and structured data corresponding to the database query; and
a document generator (414) configured to generate a presentation document based on the information management project, the presentation document comprising the unstructured content and the structured data.

7. The computer system (100) of claim 6, wherein the instruction modules comprise a query optimizer (210) configured to analyze at least one database query included in the project and generate a query plan.

8. The computer system (100) of claim 6, wherein the instruction modules comprise a file browser (204) configured to access a stored document and enable the selection of a portion of the document for incorporation into the information management project.

9. The computer system (100) of claim 6, wherein the instruction modules comprise a Web browser (202) configured to access a Web page (128) and enable the selection of a portion of the Web page (128) for incorporation into the information management project.

10. The computer system (100) of claim 6, wherein the instruction modules comprise a query interface (208) configured to enable the construction of the database query corresponding to the second item, wherein the second item comprises at least one of a data table, a chart, and a graph.

11. The computer system (100) of claim 6, wherein the project is stored to a shared storage location and two or more project authors work collaboratively to develop the project's content.

12. A non-transitory, computer-readable medium (400), comprising code configured to direct a processor (402) to:
add a first item to an information management project (406), the first item comprising unstructured content selected from an unstructured data source and a data link corresponding to the unstructured content;
add a second item to the information management project (406), the second item comprising a database query and structured data corresponding to the database query; and
generate a presentation document used on the information management project, the presentation document comprising the unstructured content and the structured data (414).

13. The non-transitory, computer-readable medium of claim 12, comprising code configured to direct the processor to access a Web page (410) and generate the data link, wherein the data link identifies a selected portion of the Web page.

14. The non-transitory, computer-readable medium of claim 12, comprising code configured to direct the processor (402) to initiate a media capture interface (412) and add a third item to the information management project, the third item comprising media content captured by the media capture interface (412).

15. The non-transitory, computer-readable medium of claim 12, comprising code configured to direct the processor (402) to update the information management project by reloading the unstructured content identified by the data link and re-executing the database query.
